(19) United States
(12) Patent Application Publication
(10) Pub. No.: US 2026/0196463 A1
(43) Pub. Date: Jul. 9, 2026

(54) Method of Manufacturing Electrode Assembly, Electrode Assembly Manufactured Therefrom, and Battery Cell Comprising the Same

(71) Applicant: SK On Co., Ltd., Seoul (KR)

(72) Inventor: Jeong Gyu PARK, Daejeon (KR)

(21) Appl. No.: 19/438,715

(22) Filed: Jan. 2, 2026

(30) Foreign Application Priority Data
Jan. 3, 2025 (KR) 10-2025-0000874

(51) Int. Cl. H01M 4/04; H01M 4/02; H01M 4/38; H01M 10/0525; H01M 10/0587

(52) U.S. Cl. CPC H01M 4/0409; H01M 4/0416; H01M 4/386; H01M 10/0525; H01M 10/0587; H01M 2004/021

(57) ABSTRACT

The present disclosure relates to a method of manufacturing an electrode assembly, an electrode assembly manufactured thereby, and a battery cell including the same. According to an embodiment, the method of manufacturing an electrode assembly may include: a conveying step of conveying an electrode sheet; a first rolling step of rolling the electrode sheet conveyed in the conveying step; and a winding step of winding the electrode sheet rolled in the first rolling step, wherein the winding step may be performed such that a region of the electrode sheet rolled in the first rolling step is wound within 10 minutes.

### CROSS-REFERENCE TO RELATED PATENT APPLICATION

The present application claims priority under 35 U.S.C. § 119(a) to Korean patent application number 10-2025-0000874 filed on Jan. 3, 2025, in the Ministry of Intellectual Property, the entire disclosure of which is incorporated by reference herein.

### BACKGROUND OF THE INVENTION

### 1. Field

The present disclosure relates to a method of manufacturing an electrode assembly, an electrode assembly manufactured thereby, and a battery cell including the electrode assembly.

### 2. Description of the Related Art

A battery cell is an example of a basic unit constituting a secondary battery and may generally include an electrode assembly that generates electrical energy and an exterior member that accommodates the electrode assembly. The battery cell may be classified into a can-type battery cell and a pouch-type battery cell depending on the shape of the exterior member and other intended uses, and the can-type battery cell may be further classified into a cylindrical battery cell and a prismatic battery cell. Meanwhile, the electrode assembly may be classified into a winding type, a stacking type, a stack-folding type, or a zigzag-folding type depending on the shape of the exterior member and other intended uses.

The electrodes constituting the electrode assembly may be manufactured through a process of applying and drying an electrode slurry containing an active material on an electrode plate and a process of rolling the electrode to adjust its volume and density. However, even when the electrode is rolled, a phenomenon occurs in which the thickness tends to recover over time due to accumulated stress (spring-back phenomenon). As a result, when subsequent processes are performed after rolling, the thickness may become greater than the initially intended thickness. If an electrode manufactured under such conditions is to be accommodated in the exterior member, accommodation may become impossible due to the increased thickness resulting from spring-back, or various process defects may occur, such as thickness variation between electrode lots due to non-uniform thickness increase over time.

To prevent such issues, attempts have been made in winding-type electrode assemblies to design the center value of the diameter to be smaller so that a tolerance is secured relative to the accommodation volume of the exterior member. However, designing the electrode assembly in this manner increases empty space inside the exterior member relative to the available accommodation volume, which may disadvantageously reduce the energy density of the resulting battery cell.

### SUMMARY OF THE INVENTION

According to one aspect of the present disclosure, a method of manufacturing an electrode assembly capable of suppressing or minimizing a spring-back phenomenon of an electrode caused by rolling may be provided.

According to another aspect of the present disclosure, a method of manufacturing an electrode assembly with further improved processability may be provided.

According to still another aspect of the present disclosure, an electrode assembly and a battery cell with further improved energy density per volume may be provided.

Meanwhile, the present disclosure may be widely applied to fields of green technology such as electric vehicles, battery charging stations, energy storage systems (ESS), photovoltaics, and wind power, which utilize batteries. In addition, the present disclosure may be used in eco-friendly mobility, including electric vehicles and hybrid vehicles, to suppress air pollution and greenhouse gas emissions and thereby prevent climate change.

As a technical means to achieve the technical objects, a method of manufacturing an electrode assembly according to the present disclosure may include: a conveying step of conveying an electrode sheet; a first rolling step of rolling the electrode sheet conveyed in the conveying step; and a winding step of winding the electrode sheet rolled in the first rolling step, wherein the winding step may be performed such that a region of the electrode sheet rolled in the first rolling step is wound within 10 minutes.

In a method of manufacturing an electrode assembly according to an embodiment, the first rolling step may include rolling the electrode sheet so that it has a thickness of 60% to 85% of its thickness before rolling.

In a method of manufacturing an electrode assembly according to an embodiment, the first rolling step may include rolling the electrode sheet at a rolling speed of 20 m/min to 150 m/min.

In a method of manufacturing an electrode assembly according to an embodiment, the electrode sheet may include an electrode plate and an electrode active material layer formed on at least one surface of the electrode plate, and the first rolling step may include rolling the electrode sheet such that the electrode active material layer has a density of 1.4 g/cm³ to 1.8 g/cm³.

In a method of manufacturing an electrode assembly according to an embodiment, the winding step may include winding the electrode sheet when a spring-back ratio of a region of the electrode sheet rolled in the first rolling step is 0.001% to 15%.

In a method of manufacturing an electrode assembly according to an embodiment, the method may further include, before the first rolling step, an electrode sheet preparation step comprising a coating step of applying an electrode active material slurry to an electrode plate and a drying step of drying the electrode plate to which the electrode active material slurry has been applied in the coating step.

In a method of manufacturing an electrode assembly according to an embodiment, the electrode active material may include a silicon-based active material.

In a method of manufacturing an electrode assembly according to an embodiment, the electrode sheet preparation step may further include a second rolling step of rolling the electrode plate to which the electrode active material slurry has been applied after the coating step.

In a method of manufacturing an electrode assembly according to an embodiment, the electrode sheet may include a positive electrode sheet and a negative electrode sheet, and the winding step may include winding the positive electrode sheet and the negative electrode sheet together with a separator.

In a method of manufacturing an electrode assembly according to an embodiment, the electrode sheet may be a negative electrode sheet, and the winding step may include winding the negative electrode sheet together with a positive electrode sheet and a separator.

In a method of manufacturing an electrode assembly according to an embodiment, the winding step may include winding the electrode sheet 40 to 70 times.

In a method of manufacturing an electrode assembly according to an embodiment, in a method of manufacturing an electrode assembly using an electrode assembly manufacturing system including a first roll press for rolling the electrode sheet and a winder for winding the electrode sheet, the method may include: a conveying step of conveying the electrode sheet; a first rolling step of rolling the electrode sheet conveyed in the conveying step by using the first roll press; and a winding step of winding the electrode sheet rolled in the first rolling step by using the winder.

As a technical means to achieve the technical objects, an electrode assembly according to the present disclosure may be manufactured by the method of manufacturing an electrode assembly according to the present disclosure and may have a jelly-roll shape wound around a winding shaft.

In an electrode assembly according to an embodiment, a diameter of the electrode assembly may be 40 mm to 46 mm.

As a technical means to achieve the technical objects, a battery cell according to the present disclosure may include the electrode assembly according to the present disclosure.

According to one aspect of the present disclosure, there may be provided a method of manufacturing an electrode assembly capable of suppressing or minimizing a spring-back phenomenon of an electrode caused by rolling.

According to another aspect of the present disclosure, there may be provided a method of manufacturing an electrode assembly with further improved processability.

According to still another aspect of the present disclosure, there may be provided an electrode assembly and a battery cell having further improved energy density per unit volume.

Meanwhile, the present disclosure may be widely applied to green technology fields such as electric vehicles, battery charging stations, energy storage systems (ESS), photovoltaics, and wind power, which utilize batteries. In addition, the present disclosure may be used in eco-friendly mobility, including electric vehicles and hybrid vehicles, to suppress air pollution and greenhouse gas emissions and thereby prevent climate change.

### BRIEF DESCRIPTION OF THE DRAWINGS

FIG. 1 is a diagram illustrating an example of a method of manufacturing an electrode assembly according to an embodiment of the present disclosure.

FIG. 2 is a diagram illustrating another example of a method of manufacturing an electrode assembly according to an embodiment of the present disclosure.

FIG. 3 is a diagram illustrating still another example of a method of manufacturing an electrode assembly according to an embodiment of the present disclosure.

FIG. 4 is a diagram illustrating an example of an electrode assembly manufacturing system used in a method of manufacturing an electrode assembly according to an embodiment of the present disclosure.

FIG. 5 is a diagram illustrating another example of an electrode assembly manufacturing system used in a method of manufacturing an electrode assembly according to an embodiment of the present disclosure.

FIG. 6 is a graph showing a change in thickness over time, observed from immediately after rolling an electrode sheet of a fabrication example.

FIG. 7 is a graph showing a change over time obtained by deriving a spring-back thickness value from the graph of FIG. 6.

### DETAILED DESCRIPTION

The embodiments described in the present specification may be modified into various other forms, and thus the technology according to an embodiment is not limited to the embodiments described below. Furthermore, throughout the specification, the expressions “comprise,” “include,” “contain,” or “have” in relation to any element are intended to indicate that the element may include other elements unless expressly stated otherwise, and do not exclude additional elements, materials, or processes not explicitly listed.

In the present specification, unless otherwise specified, “the same” or “uniform” may mean that they are identical or uniform within an acceptable margin of error. For example, stating that certain structures or physical property measurement values are the same may include not only being completely identical but also being identical within a range of error. Meanwhile, stating that physical property measurement values are the same may mean that the difference in measured values between objects is less than about 5%, specifically less than 3%, and more specifically less than 1%.

In the present specification, stating that the angle formed between two objects is perpendicular, or that they are parallel or aligned, may include not only geometrically perpendicular or parallel but also within a slight margin of error.

The numerical ranges used in the present specification include the lower limit, the upper limit, all values within the range, increments logically derived from the form and breadth of the defined range, all values doubly limited, and all possible combinations of upper and lower limits defined in different forms.

Unless specifically defined otherwise, the term “about” may refer to a value within 30%, 25%, 20%, 15%, 10%, or 5% of the stated value.

In the present specification, the use of terms such as “first,” “second,” and “third” before components is merely for distinguishing components from each other and does not relate to order, importance, or hierarchical relationship. For example, an invention including only a second component without a first component may also be implemented.

In the present specification, the “X-direction,” “Y-direction,” and “Z-direction” may each refer to one direction of an orthogonal coordinate system perpendicular to one another in three-dimensional space.

In the present specification, a configuration defined as “ . . . part,” “ . . . module,” or “ . . . unit” may refer, without limitation, to a single component or a collection of two or more identical or similar components that share a functional aspect, and the collection of components may be configured by an unrestricted combination of hardware and/or software.

In the present specification, the expression “is disposed” may refer, without limitation, to any positional relationship in which one object is positioned adjacent to another object. Non-limiting examples include coating one object onto another object; adhering one object to another using an adhesive; attaching one object to another by applying heat or pressure; simply positioning an object so that at least a portion thereof contacts at least a portion of another object in any space; or fixing the object in such a positioned state.

The term “secondary battery” used in the present specification may refer to a battery that generates electrical energy through an oxidation-reduction reaction when ions—specifically cations such as lithium ions—are inserted into or extracted from a positive electrode and a negative electrode. Specifically, the “secondary battery” may refer to any one of a lithium cobalt battery, a lithium high-nickel battery, a lithium iron phosphate battery, a lithium-ion battery, a lithium polymer battery, a lithium-sulfur battery, a nickel-metal hydride battery, a nickel-cadmium battery, a sodium battery, or an all-solid-state battery. More specifically, the term “secondary battery” used in the present specification may refer to a lithium-ion secondary battery, but is not limited thereto.

Hereinafter, the present disclosure will be described in detail. However, this is merely exemplary, and the present disclosure is not limited to the specific embodiments described by way of example.

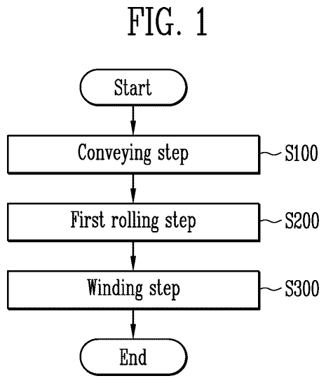

FIG. 1 is a diagram illustrating an example of a method of manufacturing an electrode assembly according to an embodiment of the present disclosure.

Referring to FIG. 1, a method of manufacturing an electrode assembly according to an embodiment of the present disclosure may comprise: a conveying step S100 of conveying an electrode sheet; a first rolling step S200 of rolling the electrode sheet conveyed in the conveying step; and a winding step S300 of winding the electrode sheet rolled in the first rolling step S200, wherein the winding step S300 may be performed such that a region of the electrode sheet rolled in the first rolling step S200 is wound within 10 minutes.

In one embodiment, the electrode sheet may refer to an electrode sheet for manufacturing a secondary battery. In a more specific embodiment, the electrode sheet may refer to an electrode sheet for manufacturing electrodes used in a secondary battery.

In one embodiment, the electrode sheet may include an electrode plate and an electrode active material applied to at least one surface of the electrode plate. The electrode active material may be applied, for example, in the form of a slurry. That is, in such an embodiment, the electrode sheet may include the electrode plate and an electrode active material slurry applied to at least one surface of the electrode plate. The electrode active material slurry applied to at least one surface of the electrode plate may form an electrode active material layer on the at least one surface of the electrode plate.

Detailed configurations and compositions of the electrode plate and the electrode active material will be described later.

In one embodiment, the electrode sheet may extend in one direction. That is, in one embodiment, the electrode sheet may have a shape extending in one direction. Such a shape of the electrode sheet may be conveyed in a predetermined direction during the manufacturing process as will be described later, and as it is conveyed in the predetermined direction, various processes may be performed continuously on each region of the electrode sheet or intermittently along predetermined intervals.

Meanwhile, in such an embodiment, the electrode plate may also have a shape extending in one direction, and the electrode active material slurry may likewise be applied in a form extending in one direction on at least one surface of the electrode plate.

In one embodiment, the conveying step S100 may refer to a step of conveying an electrode sheet.

As described above, since the electrode sheet may have a shape extending in one direction, the electrode sheet may be continuously conveyed in the conveying step S100.

In such an embodiment, the conveying step S100 may be initiated earlier than at least one of the other steps except the conveying step S100, and specifically, may be initiated first among the steps other than the conveying step S100. The initiated conveying step S100 may be performed at least in parallel with the steps other than the conveying step S100.

In one embodiment, the first rolling step S200 may refer to a step of rolling the electrode sheet conveyed in the conveying step S100.

In an exemplary embodiment, the first rolling step S200 may be performed by roll-pressing in order to roll the electrode sheet that is continuously conveyed, but the present disclosure is not limited thereto.

By the first rolling step S200, the electrode sheet may be rolled to a desired thickness. In particular, an electrode active material slurry applied and cured on the electrode plate, that is, an electrode active material layer formed in a stacked manner on the electrode plate, may be rolled to a desired thickness. Through such rolling, the composite density and volume of the electrode active material layer may be adjusted.

In one embodiment, the first rolling step S200 may include rolling the electrode sheet such that it has a thickness of 60% to 85% of its thickness before rolling.

For example, if the thickness of the electrode sheet before the first rolling step S200 is 100 μm, the electrode sheet may be rolled such that the thickness after the first rolling step S200 is 60 μm to 85 μm.

If the first rolling step S200 is performed such that the electrode sheet has a thickness of less than 60% of its thickness before rolling, the pressure applied to the electrode sheet may become excessive, causing various process defects such as breakage. Conversely, if the rolling is performed such that the electrode sheet has a thickness exceeding 85% of its thickness before rolling, the energy density per weight and per volume of the final manufactured electrode may become inferior. In particular, the absolute amount of active material accommodated in the exterior member may be reduced and/or empty space inside the exterior member may increase, thereby causing a reduction in the energy density per battery cell.

In one embodiment, the first rolling step S200 may include rolling the electrode sheet at a rolling speed of 20 m/min to 150 m/min.

Specifically, the first rolling step S200 may include rolling the electrode sheet at a rolling speed of 20 m/min to 30 m/min.

Alternatively, the first rolling step S200 may include rolling the electrode sheet at a rolling speed of 100 m/min to 150 m/min.

If the rolling speed is less than 20 m/min, the process time may become excessively long and processability may become inferior. If the rolling speed exceeds 150 m/min, the rolling may not be properly performed, making it difficult to achieve the intended objectives of the rolling step.

In one embodiment, the electrode sheet may include an electrode plate and an electrode active material layer formed on at least one surface of the electrode plate, and the first rolling step S200 may include rolling the electrode sheet such that the electrode active material layer has a density of 1.4 g/cm³ to 1.8 g/cm³.

If the density is lower than the above-described range, the energy density of a battery cell including the electrode may become inferior. If the density exceeds the above-described range, electrode breakage may occur during the first rolling step S200, or excessive spring-back of the electrode may occur after the first rolling step S200.

In one embodiment, the winding step S300 may refer to a step of winding the electrode sheet rolled in the first rolling step S200.

By the winding step S300, the electrode sheet may be wound. In a specific embodiment, the electrode sheet rolled in the first rolling step S200 may be wound. Meanwhile, as will be described later, the winding step S300 may include winding a separator together with the electrode sheet, thereby forming an electrode assembly in a jelly-roll shape in which the electrode sheet and the separator are wound together.

In one embodiment, the winding step S300 may be performed such that a region of the electrode sheet rolled in the first rolling step S200 is wound within 10 minutes.

In one embodiment, when the winding step S300 is performed such that a region of the electrode sheet rolled in the first rolling step S200 is wound within 10 minutes—meaning that the region rolled in the first rolling step S200 is wound within 10 minutes—the electrode sheet can be wound before its thickness increases excessively, thereby minimizing thickness increase caused by spring-back. Furthermore, by winding the electrode sheet at a time when the thickness increase rate due to spring-back becomes steep, as will be described later, the spring-back phenomenon can be maximally suppressed by an external force (elastic force) generated by winding and a repulsive force applied from the case into which the electrode assembly is inserted.

In one embodiment, the winding step S300 may include winding the electrode sheet when a spring-back ratio of a region of the electrode sheet rolled in the first rolling step S200 is 0.001% to 15%.

In one embodiment, the spring-back ratio may be defined as a rate of thickness increase caused by a spring-back phenomenon during a predetermined period of time after the electrode sheet is rolled.

From this perspective, in one embodiment, the spring-back ratio may satisfy the relationship defined by Equation 1 below.

$$Spring - back ratio ( \% ) = ( ( {T}_{t} - {T}_{o} ) / ( {T}_{s} - {T}_{o} ) ) \times 100 \qquad [ Equation 1 ]$$

In Equation 1,
Tₒ is the thickness of the electrode sheet rolled in the first rolling step,
Tₜ is the thickness of the electrode sheet at a specific point in time after rolling, and
Tₛ is the thickness of the electrode sheet when a spring-back saturation state is reached.

In one embodiment, Tₒ may refer to the thickness of the electrode sheet immediately after rolling. The thickness may refer to, for example, the thickness of the electrode sheet measured between 0.1 seconds and 30 seconds after rolling.

In one embodiment, Tₜ may refer to the thickness of the electrode sheet after t minutes have elapsed following the rolling. Tₜ may serve as a reference value for determining whether the time point falls within a range in which winding can be performed after rolling according to the above-described embodiment.

In one embodiment, Tₛ may refer to the thickness of the electrode sheet when a spring-back saturation state is reached.

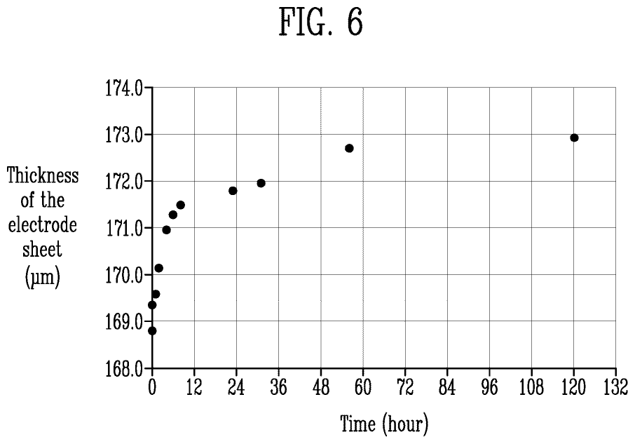

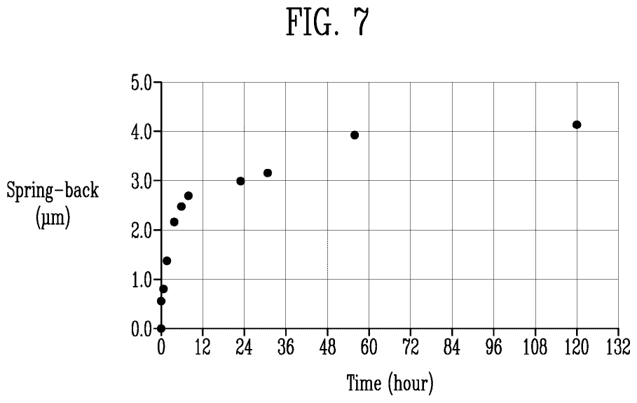

As will be described later with reference to FIGS. 6 and 7, when a spring-back phenomenon occurs after rolling, a rapid increase in thickness may initially be observed, after which the degree of thickness increase gradually decreases over time. After a certain period of time, the thickness increase may eventually become almost unobservable. The state of the electrode sheet at the time point at which the thickness increase becomes almost unobservable may be defined as the spring-back saturation state.

From this perspective, in the present specification, the spring-back saturation state may be defined as the time point at which 7,200 minutes have elapsed after rolling. In this regard, the thickness of the electrode sheet that has reached the spring-back saturation state may be defined as the thickness of the electrode sheet at the time point 7,200 minutes after rolling.

In one embodiment, when the electrode sheet is wound at the time when the above-described spring-back ratio satisfies the numerical range, the electrode assembly manufactured thereby may be wound within an appropriate range, and the energy density of a battery cell including the electrode assembly may be improved.

In one embodiment, when the region of the electrode sheet rolled in the first rolling step S200 is wound within 10 minutes, the winding may be performed at a time when the rate of thickness increase due to spring-back becomes steep, thereby enabling manufacture of an electrode assembly in a state in which the thickness increase due to spring-back is minimized.

In one embodiment, the first rolling step S200 and the winding step S300 may be performed sequentially. That is, in such an embodiment, the process following the first rolling step S200 may be the winding step S300.

In one embodiment, by winding the electrode sheet rolled in the first rolling step S200 in the manner described above, the thickness increase of the electrode caused by a spring-back phenomenon may be suppressed or minimized.

That is, in one embodiment, by winding the rolled electrode sheet at a time when the spring-back ratio of the rolled electrode sheet is observed to be at or below a certain level—namely, by winding at a time when the rate of thickness increase due to spring-back becomes steep—the spring-back phenomenon may be maximally suppressed by an external force (elastic force) generated by winding and a repulsive force from the case into which the electrode assembly is inserted. In such an embodiment, process defects caused by electrode thickness increase due to spring-back may be improved. In addition, variations in battery cell quality and energy density due to thickness deviation caused by spring-back may be suppressed or minimized. Moreover, since it is unnecessary to design tolerances to accommodate such thickness increase or deviation, a high-energy-density battery cell can be achieved.

In one embodiment, the electrode sheet and separator wound to a desired degree in the winding step S300 may be cut to form an electrode assembly in a wound shape.

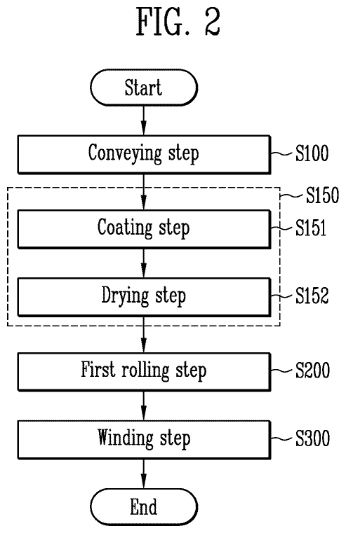

FIG. 2 is a diagram illustrating another example of a method of manufacturing an electrode assembly according to an embodiment of the present disclosure.

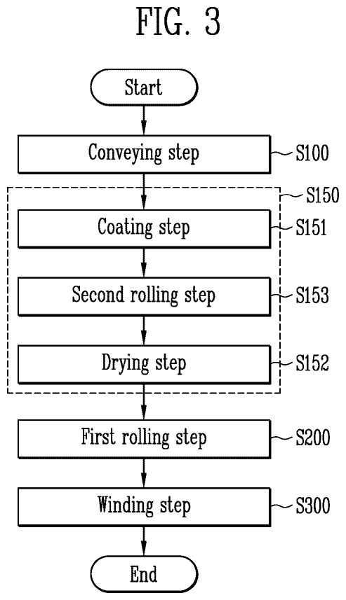

FIG. 3 is a diagram illustrating still another example of a method of manufacturing an electrode assembly according to an embodiment of the present disclosure.

Referring to FIG. 2, in one embodiment, before the first rolling step S200, the method may further include an electrode sheet preparation step S150 comprising: a coating step S151 of applying an electrode active material slurry to an electrode plate; and a drying step S152 of drying the electrode plate to which the electrode active material slurry has been applied in the coating step S151.

In one embodiment, as described above, the electrode sheet may include an electrode plate and an electrode active material applied to at least one surface of the electrode plate. The electrode active material may be applied, for example, in the form of a slurry.

Meanwhile, as will be described later, the electrode sheet may be either a positive electrode sheet or a negative electrode sheet.

In one embodiment, when the electrode sheet is a positive electrode sheet, the positive electrode sheet may include a positive electrode plate and a positive electrode active material.

According to an exemplary embodiment, the positive electrode plate may include a conductive material known in the art that does not cause a chemical reaction in a lithium secondary battery. For example, the positive electrode plate may include any one of stainless steel, nickel (Ni), aluminum (Al), titanium (Ti), copper (Cu), or alloys thereof, and may be provided in various forms such as a film, sheet, or foil.

According to an exemplary embodiment, the positive electrode active material may include a material into which lithium ions can be inserted and from which lithium ions can be desorbed. For example, the positive electrode active material may be a lithium metal oxide.

According to exemplary embodiments, the positive electrode active material may include a lithium-transition metal composite oxide. In a specific example, the positive electrode active material may include a lithium-nickel composite oxide. The lithium-nickel composite oxide may further include at least one of cobalt (Co), manganese (Mn), and aluminum (Al).

In some embodiments, the positive electrode active material or the lithium-nickel composite oxide may include a layered structure or crystal structure represented by Chemical Formula 1 below.

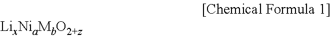

In Chemical Formula 1, x may satisfy 0.9≤x≤1.2, a may satisfy 0.6≤a≤0.99, b may satisfy 0.01≤b≤0.4, and z may satisfy −0.5≤z≤0.1. As described above, M may include Co, Mn, and/or Al.

The chemical structure represented by Chemical Formula 1 illustrates bonding relationships included in the layered structure or crystal structure of the positive electrode active material and does not exclude additional elements. For example, M may include Co and/or Mn, and Co and/or Mn may be provided as main active elements together with Ni in the positive electrode active material. Chemical Formula 1 is provided to illustrate the bonding relationships among such main active elements and should be understood as encompassing the introduction or substitution of additional elements.

Meanwhile, in an exemplary embodiment, the positive electrode active material or the lithium-nickel composite oxide may include a layered structure or crystal structure represented by Chemical Formula 1-1 below.

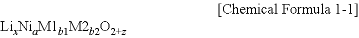

In Chemical Formula 1-1, M₁ may include Co, Mn, and/or Al. M₂ may include the above-described auxiliary elements. In Chemical Formula 1-1, x may satisfy 0.9≤x≤1.2, a may satisfy 0.6≤a≤0.99, b₁+b₂ may satisfy 0.01≤b₁+b₂≤0.4, and z may satisfy −0.5≤z≤0.1.

In one embodiment, the positive electrode active material may include a lithium metal oxide. Specifically, the positive electrode active material may include the above-described lithium-nickel composite oxide, a lithium iron phosphate (LFP) oxide represented by LiFePO₄, or a lithium cobalt oxide (LCO) represented by LiCoO₂.

In one embodiment, when the electrode sheet is a negative electrode sheet, the negative electrode sheet may include a negative electrode plate and a negative electrode active material.

According to an exemplary embodiment, the negative electrode plate may include a conductive material known in the art that does not cause a chemical reaction in a lithium secondary battery. Non-limiting examples of the negative electrode plate include copper foil, nickel foil, stainless steel foil, titanium foil, nickel foam, copper foam, and polymer substrates coated with a conductive metal.

According to an exemplary embodiment, the negative electrode active material may be a material capable of absorbing and desorbing lithium ions. Examples of such negative electrode active materials include carbon-based materials such as crystalline carbon, amorphous carbon, carbon composites, and carbon fibers; lithium metal; lithium alloys; silicon-containing materials; and tin-containing materials.

Examples of the amorphous carbon include hard carbon, soft carbon, coke, mesocarbon microbeads (MCMB), and mesophase pitch-based carbon fibers (MPCF).

Examples of the crystalline carbon include graphite-based carbon materials such as natural graphite, artificial graphite, graphitized coke, graphitized MCMB, and graphitized MPCF.

The lithium metal may be pure lithium metal or lithium metal having a protective layer formed thereon to suppress dendrite growth. In one embodiment, a lithium metal-containing layer deposited or coated on a negative current collector may be used as a negative electrode active material layer. In another embodiment, a lithium thin-film layer may be used as the negative electrode active material layer.

Examples of elements included in the lithium alloy include aluminum, zinc, bismuth, cadmium, antimony, silicon, lead, tin, gallium, or indium.

The silicon-containing material may be defined as a silicon-based active material. The silicon-based active material may provide enhanced capacity characteristics. The silicon-based active material may include Si, SiOₓ (0<x<2), metal-doped SiOₓ (0<x<2), or silicon-carbon composites. The metal may include lithium and/or magnesium, and the metal-doped SiOₓ (0<x<2) may include a metal silicate.

In one embodiment, the electrode active material may include a silicon-based active material. That is, when the electrode sheet is a negative electrode sheet, the negative electrode sheet may include a silicon-based active material as the active material. A silicon-based active material may provide increased capacity characteristics; however, because it may exhibit more drastic volume-change characteristics, an electrode sheet including a silicon-based active material may exhibit more severe volume deviation caused by a spring-back phenomenon.

Non-limiting examples of solvents for the negative electrode active material include water, purified water, deionized water, distilled water, ethanol, isopropanol, methanol, acetone, n-propanol, and t-butanol.

Referring again to FIG. 2, in one embodiment, the electrode sheet preparation step S150 may include the coating step S151 and the drying step S152.

In one embodiment, the coating step S151 may refer to a step of applying an electrode active material slurry to the above-described electrode plate.

In one embodiment, the coating step S151 may be performed by a coating method such as gravure coating, slot-die coating, multilayer simultaneous die coating, imprinting, doctor blade coating, dip coating, bar coating, or casting. However, the present disclosure is not limited thereto, and various coating methods known in the art may be used.

Meanwhile, in one embodiment, the slurry may further include a binder in addition to the electrode active material, and may selectively include, as needed, a conductive additive, a thickener, and the like.

In one embodiment, the drying step S152 may refer to a step of drying the electrode plate to which the electrode active material slurry has been applied in the coating step S151.

In one embodiment, the drying step S152 may be performed by a drying method such as natural drying, air drying, vacuum drying, or thermal drying. However, the present disclosure is not limited thereto, and various drying methods known in the art may be employed. It is of course understood that the drying time and temperature may be determined in various ways according to what is known in the art.

In one embodiment, through the coating step S151 and the drying step S152, an electrode active material layer may be formed on at least one surface of the electrode plate. Meanwhile, in such an embodiment, no separate rolling process may be performed while the coating step S151 and the drying step S152 are being performed. That is, after both the coating step S151 and the drying step S152 are completed, a rolling process may be performed. Thus, in one embodiment, the coating step S151 and the drying step S152 may be performed before the first rolling step S200 is carried out.

In one embodiment, the electrode sheet preparation step S150 may further include a slitting step (not shown) performed between the coating step S151 and the drying step S152 or after the coating step S151 and the drying step S152 are completed. Through the slitting step (not shown), the electrode sheet may be cut to a desired size, for example, to a width corresponding to the final electrode width to be manufactured.

In one embodiment, the electrode sheet preparation step S150 may further include a second rolling step S153 of rolling the electrode plate to which the electrode active material slurry has been applied after the coating step S151.

In one embodiment, the second rolling step S153 may refer to a step of rolling the electrode sheet conveyed in the conveying step S100, and in an exemplary embodiment, the second rolling step S153 may be performed by roll-pressing to roll the electrode sheet continuously conveyed, although the present disclosure is not limited thereto.

In such an embodiment, a rolling process may also be performed in the electrode sheet preparation step S150. In one embodiment, the second rolling step S153 may be performed between the coating step S151 and the drying step S152 or after the coating step S151 and the drying step S152 are completed.

In such an embodiment, the second rolling step S153 may be performed before the first rolling step S200 is performed. Considering that the first rolling step S200 corresponds to a rolling process performed immediately before the winding step S300, the second rolling step S153 may correspond to a rolling process performed in the electrode sheet preparation process, as in the related art.

In one embodiment, the electrode sheet may include a positive electrode sheet and a negative electrode sheet, and the winding step S300 may include winding the positive electrode sheet and the negative electrode sheet together with a separator.

In one embodiment, the electrode sheet may include a positive electrode sheet and a negative electrode sheet.

That is, in such an embodiment, the positive electrode sheet and the negative electrode sheet may respectively undergo the conveying step S100 and the first rolling step S200. In an exemplary embodiment, the positive electrode sheet and the negative electrode sheet may independently undergo the conveying step S100 and the first rolling step S200. In another exemplary embodiment, the positive electrode sheet and the negative electrode sheet may independently undergo the conveying step S100 and then undergo the first rolling step S200 together.

In one embodiment, the positive electrode sheet and the negative electrode sheet that have undergone the conveying step S100 and the first rolling step S200 may be wound together with a separator in the winding step S300 as described above.

In an exemplary embodiment, the separator may include a first separator and a second separator.

In an exemplary embodiment, one of the first separator and the second separator may be interposed between the positive electrode sheet and the negative electrode sheet, and the other separator may be disposed to contact an outer surface of either the positive electrode sheet or the negative electrode sheet relative to the interposing surface, after which the positive electrode sheet, the negative electrode sheet, the first separator, and the second separator may be wound. In a specific embodiment, the winding step S300 may include winding after arranging the components in the order of positive electrode sheet-first separator-negative electrode sheet-second separator; however, the present disclosure is not limited thereto.

In such an embodiment, the method of manufacturing an electrode assembly may include: a conveying step of conveying the positive electrode sheet and the negative electrode sheet, respectively; a first rolling step of rolling the positive electrode sheet and the negative electrode sheet conveyed in the conveying step, respectively; and a winding step of winding the positive electrode sheet and the negative electrode sheet rolled in the first rolling step together with the first separator and the second separator.

Alternatively, in such an embodiment, the method of manufacturing an electrode assembly may include: a conveying step of conveying the positive electrode sheet and the negative electrode sheet, respectively; a first rolling step of rolling the positive electrode sheet and the negative electrode sheet together as they are conveyed in the conveying step; and a winding step of winding the positive electrode sheet and the negative electrode sheet rolled in the first rolling step together with the first separator and the second separator.

Meanwhile, in such an embodiment, the separator—specifically, the first separator and the second separator—may be configured to prevent electrical short-circuiting between the positive electrode and the negative electrode in the electrode assembly, while allowing ion flow to occur.

According to an exemplary embodiment, the separator may include a porous polymer film or a porous nonwoven fabric. The porous polymer film may include a polyolefin-based polymer such as an ethylene polymer, a propylene polymer, an ethylene/butene copolymer, an ethylene/hexene copolymer, or an ethylene/methacrylate copolymer. The porous nonwoven fabric may include high-melting-point glass fibers, polyethylene terephthalate fibers, and the like. The separator may also include a ceramic material. For example, inorganic particles may be coated on the polymer film or dispersed within the polymer film to improve heat resistance.

The separator may have a single-layer or multilayer structure including the above-described polymer film and/or nonwoven fabric.

In one embodiment, the electrode sheet may be a negative electrode sheet, and the winding step S300 may include winding the negative electrode sheet together with a positive electrode sheet and a separator.

In one embodiment, the electrode sheet may be a negative electrode sheet.

That is, in such an embodiment, the negative electrode sheet may undergo the conveying step S100 and the first rolling step S200. In this embodiment, the positive electrode sheet may not undergo the first rolling step S200.

Because the tendency and degree of spring-back are more pronounced in the negative electrode manufacturing process, the first rolling step S200 may be performed only on the negative electrode sheet, and not on the positive electrode sheet, for improved processability and cost-efficiency.

In one embodiment, the negative electrode sheet that has undergone the conveying step S100 and the first rolling step S200 may be wound together with the positive electrode sheet and the separator—specifically, the positive electrode sheet, the first separator, and the second separator—in the winding step S300 as described above. In this case, as described above, the positive electrode sheet may be a positive electrode sheet that has not undergone the first rolling step S200. The details regarding the first separator and the second separator are the same as previously described, and redundant explanation will therefore be omitted.

In such an embodiment, the method of manufacturing an electrode assembly may include: a conveying step of conveying the positive electrode sheet and the negative electrode sheet, respectively; a first rolling step of rolling the negative electrode sheet conveyed in the conveying step; and a winding step of winding the negative electrode sheet rolled in the first rolling step together with the positive electrode sheet conveyed in the conveying step and the first separator and the second separator.

In such an embodiment, the positive electrode sheet may be a positive electrode sheet that has undergone the above-described second rolling step S153. The negative electrode sheet may be a negative electrode sheet that has undergone only the first rolling step S200, or both the first rolling step S200 and the second rolling step S153.

In one embodiment, the winding step S300 may include winding the electrode sheet 40 to 70 times.

In an exemplary embodiment, one winding may be defined as one full rotation of the electrode sheet caused by the winding in the winding step S300. Within such a numerical range, a high-energy-density battery cell as described above may be achieved.

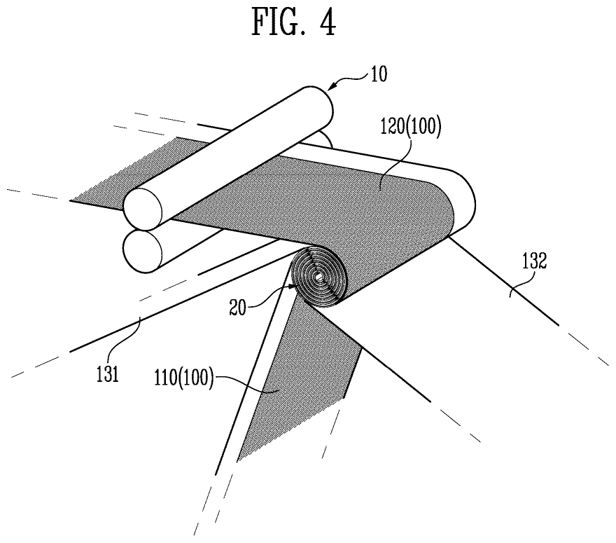

FIG. 4 is a diagram illustrating an example of an electrode assembly manufacturing system used in a method of manufacturing an electrode assembly according to an embodiment of the present disclosure.

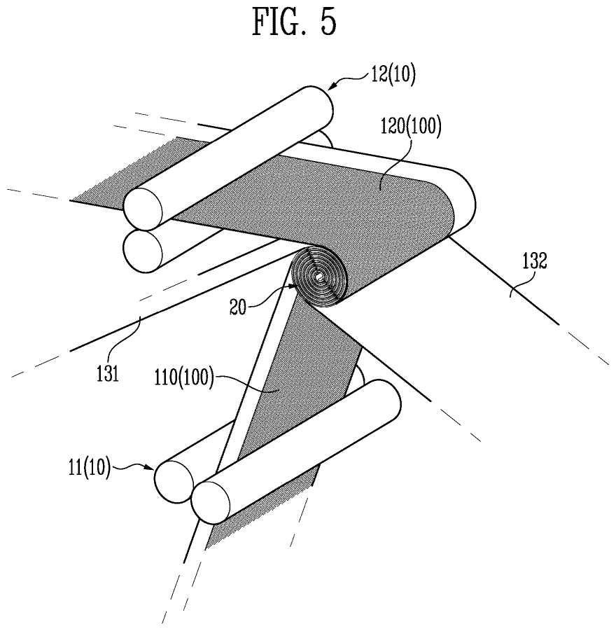

FIG. 5 is a diagram illustrating another example of an electrode assembly manufacturing system used in a method of manufacturing an electrode assembly according to an embodiment of the present disclosure.

Referring to FIGS. 4 and 5, in a method of manufacturing an electrode assembly according to an embodiment of the present disclosure using an electrode assembly manufacturing system including a first roll press 10 for rolling an electrode sheet 100 and a winder 20 for winding the electrode sheet 100, the method may include: a conveying step of conveying the electrode sheet 100; a first rolling step of rolling the electrode sheet 100 conveyed in the conveying step by using the first roll press 10; and a winding step of winding the electrode sheet 100 rolled in the first rolling step by using the winder 20.

The conveying step, the first rolling step, and the winding step are the same as the conveying step S100, the first rolling step S200, and the winding step S300 described above with reference to FIGS. 1 to 3, and all other aspects of the manufacturing method described with reference to FIGS. 1 to 3 may be applied without limitation. Hereinafter, a description will be provided of an electrode assembly manufacturing system that may be used in the method of manufacturing an electrode assembly according to an embodiment of the present disclosure.

In one embodiment, the electrode assembly manufacturing system may include an unwinder (not shown). The unwinder (not shown) may be located at the most upstream side of the manufacturing system and may convey the electrode sheet 100 by rotating in synchronization with the first roll press 10 and the winder 20.

Referring to FIGS. 4 and 5, in one embodiment, the electrode assembly manufacturing system may include the first roll press 10. In one embodiment, the first roll press 10 may include two opposing rollers for roll-to-roll pressing. The electrode sheet may be rolled by passing between the two rollers.

In one embodiment, the electrode sheet 100 may be rolled as it passes through the first roll press 10, whereby the first rolling step is performed.

Referring to FIGS. 4 and 5, in one embodiment, the electrode assembly manufacturing system may include a winder 20. The winder 20 may include a mandrel, and as the winder rotates, the electrode sheet adjacent to or in contact with the winder may be wound.

Meanwhile, in FIGS. 4 and 5, for convenience of explanation, the winder 20 that winds an electrode assembly in a cylindrical shape is illustrated; however, the present disclosure is not limited thereto. The winder 20 may instead be configured to wind the electrode assembly into a substantially prismatic shape, as needed.

In one embodiment, the electrode sheet 100 may be wound by the winder 20, whereby the winding step may be performed.

In one embodiment, the first roll press 10 and the winder 20 may be positioned adjacent to each other. In another embodiment, the first roll press 10 and the winder 20 may be provided as components within the same device, for example, as components of a winding apparatus included in the electrode assembly manufacturing system.

Referring to FIG. 4, one example of the positive electrode sheet 110, the negative electrode sheet 120, the first separator 131, and the second separator 132 being wound by the winder 20 is illustrated.

In one embodiment, the electrode assembly manufacturing system may include the first roll press 10 and the winder 20, and the negative electrode sheet 120 may be wound by the winder 20 after the first rolling step is performed using the first roll press 10. In such an embodiment, the positive electrode sheet 110 may be wound by the winder 20 without undergoing the first rolling step by the first roll press 10.

Referring to FIG. 5, another example of the positive electrode sheet 110, the negative electrode sheet 120, the first separator 131, and the second separator 132 being wound by the winder 20 is illustrated.

In one embodiment, the electrode assembly manufacturing system may include the first roll press 10 and the winder 20, and the first roll press 10 may include a first-first roll press 11 for rolling the positive electrode sheet 110 and a first-second roll press 12 for rolling the negative electrode sheet 120.

In such an embodiment, the positive electrode sheet 110 may be wound by the winder 20 after the first rolling step is performed using the first-first roll press 11, and the negative electrode sheet 120 may be wound by the winder 20 after the first rolling step is performed using the first-second roll press 12.

In addition, the electrode assembly manufacturing system may further include a coater for applying an electrode active material slurry to the electrode plate, a drying apparatus for drying the electrode sheet, a second roll press for performing the above-described second rolling step on the electrode sheet, and a slitter for slitting the electrode sheet.

An electrode assembly according to an embodiment of the present disclosure may be manufactured by the method of manufacturing an electrode assembly according to an embodiment of the present disclosure described above, and may be a jelly-roll-type electrode assembly wound about a winding axis.

In one embodiment, the electrode assembly may be a jelly-roll-type electrode assembly in which the positive electrode, the negative electrode, and the separator are wound together.

In one embodiment, the diameter of the electrode assembly may be 40 mm to 46 mm. The diameter of the electrode assembly may refer to the length of an imaginary straight line connecting two points on the circumference of a cross-section of the electrode assembly, where the cross-section is formed by cutting the electrode assembly along a plane perpendicular to the winding axis.

A battery cell according to an embodiment of the present disclosure may include the electrode assembly described above.

In one embodiment, the battery cell may be a can-type battery cell including the electrode assembly, specifically a cylindrical battery cell or a prismatic battery cell, although the present disclosure is not limited thereto.

In one embodiment, when the battery cell is a cylindrical can-type battery cell, its form factor may be a cylindrical cell such as 18650, 21700, 26650, 32700, 32140, 46110, 4680, 4695, 48110, 4875, or 4880. In a specific embodiment, the form factor may be 46110, 4680, 4695, 48110, 4875, or 4880. In a more specific embodiment, the form factor of the battery cell may be 4680, which has a diameter of approximately 46 mm and a height of approximately 80 mm, although the present disclosure is not limited thereto.

The electrode assembly manufactured according to an embodiment of the present disclosure may be preferably used not only in battery cells serving as power sources for small-sized devices, but also as unit cells of battery modules and/or battery packs for medium- or large-sized devices including multiple battery cells. Examples of small-sized devices include mobile phones, laptop computers, and cameras, and examples of medium- or large-sized devices include electric vehicles, hybrid electric vehicles, plug-in hybrid electric vehicles, and power storage systems, although the present disclosure is not limited thereto.

Hereinafter, the embodiments of the present disclosure will be further described with reference to specific experimental examples. The embodiments and comparative examples included in the experimental examples are merely illustrative and do not limit the appended claims. It is apparent to those skilled in the art that various changes and modifications may be made to the embodiments within the scope and spirit of the present disclosure, and it is natural that such changes and modifications fall within the scope of the appended claims.

### EXAMPLE

### Preparation Example

A negative active material slurry was prepared by dispersing silicon-based compound particles SiOₓ (0≤x≤30), artificial graphite, a conductive material (SWCNT), styrene-butadiene rubber (SBR), and carboxymethyl cellulose (CMC) in water at a weight ratio of 1:96.9:0.2:0.6:1.3.

The negative active material slurry prepared as described above was uniformly applied to a copper foil using a slot-die coater and vacuum dried at a predetermined temperature to manufacture an electrode sheet. The thickness of the electrode sheet, measured as the combined thickness of the copper foil and the slurry layer, was measured to be an average of 250 μm.

### Evaluation Example

FIG. 6 is a graph showing a change in thickness over time, observed from immediately after rolling an electrode sheet of a fabrication example.

FIG. 7 is a graph showing a change over time obtained by deriving a spring-back thickness value from the graph of FIG. 6.

The electrode sheet manufactured in the Preparation Example was rolled at an average speed of 25 m/min using a roll press. The change in thickness of the rolled electrode sheet was observed over time starting immediately after rolling, and the results are shown in Table 1 below and FIG. 6.

(In Table 1 below, the time represents the elapsed time after the rolling was performed, and the thickness of the electrode sheet represents the average thickness of the electrode sheet.)

TABLE 1

| Time (min) | Thickness of the electrode sheet (μm) |
|---|---|
| 0 | 168.8 |
| 10 | 169.3 |
| 60 | 169.6 |
| 120 | 170.2 |
| 240 | 171.0 |
| 360 | 171.3 |
| 480 | 171.5 |
| 1380 | 171.8 |
| 1860 | 171.9 |
| 3360 | 172.7 |
| 7200 | 172.9 |

Meanwhile, the spring-back thickness values derived from Table 1 were illustrated in FIG. 7. In FIG. 7, the spring-back thickness value at time a was obtained by subtracting the thickness value of the electrode sheet at 0 hours after rolling (i.e., immediately after rolling) from the thickness value of the electrode sheet at a hours after rolling.

Referring to Table 1, FIG. 6, and FIG. 7, it was confirmed that, immediately after rolling, the rate of thickness increase due to spring-back was significantly high, but gradually decreased over time and eventually reached a spring-back saturation state in which the thickness increase was scarcely observed with further passage of time.

Accordingly, when the method of manufacturing an electrode assembly according to an embodiment of the present disclosure is employed, the electrode sheet can be wound at a time point at which the rate of thickness increase due to spring-back is significant, thereby minimizing the thickness increase caused by spring-back. Therefore, as described above, post-process defects caused by the increase in electrode thickness due to spring-back can be improved, and defects in electrode quality caused by thickness deviation due to spring-back can also be improved.

The foregoing description is merely an example applying the principles of the present disclosure, and additional configurations may be included without departing from the scope of the present disclosure.

What is claimed is:

1. A method of manufacturing an electrode assembly, comprising:
a conveying step of conveying an electrode sheet;
a first rolling step of rolling the electrode sheet conveyed in the conveying step; and
a winding step of winding the electrode sheet rolled in the first rolling step;
wherein the winding step is performed such that a region of the electrode sheet rolled in the first rolling step is wound within 10 minutes.

2. The method of manufacturing an electrode assembly according to claim 1, wherein the first rolling step comprises rolling the electrode sheet so that it has a thickness of 60% to 85% of its thickness before rolling.

3. The method of manufacturing an electrode assembly according to claim 1, wherein the first rolling step comprises rolling the electrode sheet at a rolling speed of 20 m/min to 150 m/min.

4. The method of manufacturing an electrode assembly according to claim 1, wherein the electrode sheet includes an electrode plate and an electrode active material layer formed on at least one surface of the electrode plate, and wherein the first rolling step is a manufacturing method of an electrode assembly of rolling the electrode sheet such that the electrode active material layer has a density of 1.4 g/cm³ to 1.8 g/cm³.

5. The method of manufacturing an electrode assembly according to claim 1, wherein the winding step comprises winding the electrode sheet when a spring-back ratio of a region of the electrode sheet rolled in the first rolling step is 0.001% to 15%.

6. The method of manufacturing an electrode assembly according to claim 1, further comprising, before the first rolling step, an electrode sheet preparation step, wherein the electrode sheet preparation step comprises:
a coating step of applying an electrode active material slurry to an electrode plate; and
a drying step of drying the electrode plate to which the electrode active material slurry has been applied in the coating step.

7. The method of manufacturing an electrode assembly according to claim 6, wherein the electrode active material comprises a silicon-based active material.

8. The method of manufacturing an electrode assembly according to claim 6, wherein the electrode sheet preparation step further comprises a second rolling step of rolling the electrode plate to which the electrode active material slurry has been applied after the coating step.

9. The method of manufacturing an electrode assembly according to claim 1, wherein the electrode sheet comprises a positive electrode sheet and a negative electrode sheet, and wherein the winding step comprises winding the positive electrode sheet and the negative electrode sheet together with a separator.

10. The method of manufacturing an electrode assembly according to claim 1, wherein the electrode sheet is a negative electrode sheet, and wherein the winding step comprises winding the negative electrode sheet together with a positive electrode sheet and a separator.

11. The method of manufacturing an electrode assembly according to claim 1, wherein the winding step comprises winding the electrode sheet 40 to 70 times.

12. The method of manufacturing an electrode assembly according to claim 1, comprising:
a conveying step of conveying an electrode sheet;
a first rolling step of rolling the electrode sheet conveyed in the conveying step by using a first roll press; and
a winding step of winding the electrode sheet rolled in the first rolling step by using a winder.

13. An electrode assembly manufactured by the method of manufacturing an electrode assembly according to claim 1, wherein the electrode assembly being wound around a winding shaft and having a jelly-roll shape.

14. The electrode assembly according to claim 13, wherein a diameter of the electrode assembly is 40 mm to 46 mm.

15. A battery cell comprising the electrode assembly of claim 13.
